(19) United States
(12) Patent Application Publication
(10) Pub. No.: US 2026/0283209 A1
(43) Pub. Date: Sep. 24, 2026

(54) HEALTH FOOD SUPPRESSING EPIDERMAL THICKENING

(71) Applicant: FORDAYS CO., LTD., Tokyo (JP)

(72) Inventors: Nobuhiro ZAIMA, Nara (JP); Keita SUTOH, Tokyo (JP); Mica FUJITA, Tokyo (JP)

(21) Appl. No.: 19/475,797

(22) PCT Filed: Apr. 17, 2024
(86) PCT No.: PCT/JP2024/015336

§ 371 Date: Oct. 16, 2025

(30) Foreign Application Priority Data
Apr. 17, 2023 (JP) 2023-067485

(51) Int. Cl. A23L 33/175; A23L 2/66; A23L 21/10

(52) U.S. Cl. CPC A23L 33/175; A23L 2/66; A23L 21/10

(57) ABSTRACT

In the application, a health food containing nuclear proteins (nucleic acids), collagen, and arginine. The nuclear proteins (nucleic acids) are a fish milt-derived extract containing DNA and an extract of yeast and the like containing RNA. The health food further contains magnesium carbonate, chondroitin, hyaluronic acid, zinc, citric acid, vitamin C, other vitamins, emulsifiers, and the like. The health food has an action of suppressing epidermal thickening and an action of suppressing a reduction in collagen in the dermis and the like or promoting an increase in collagen in the dermis and the like by ingesting it.

### TECHNICAL FIELD

The present invention relates to a health food that suppresses thickening of the epidermis and a health food that suppresses thickening and does not reduce the collagen content in the dermis.

### BACKGROUND ART

The human epidermis prevents the loss of water and various biological components in the body, plays a role in constantly maintaining water transpiration on the body surface and body temperature, and also has a barrier function that protects the body from physical and chemical stimuli of the outside world, such as temperature, humidity, ultraviolet rays, and various chemical substances. Due to its physiological function, the human epidermis plays a very important role in the vital activity of living organisms.

However, changes in the physiological function in association with changes in the environment cause abnormalities in epidermal function, which often induces epidermal thickening, abnormalities in epidermal lipid metabolism, and the like due to disrupted turnover of the epidermis.

Chronic exposure of the face, back of the hand, and the like to ultraviolet rays causes epidermal abnormalities, epidermal thickening, and dryness of the skin. Epidermal abnormalities and epidermal thickening cause not only pathological effects on the human body, but also cosmetic losses, such as loss of skin elasticity, reduction of skin moisture, and skin texture becoming coarser. Especially since postmenopausal women experience adverse effects on the skin due to hormonal changes and the like, it is important to improve these effects.

Patent Document 1 proposes to provide an epidermal thickening inhibitor that suppresses epidermal thickening caused by exposure to ultraviolet rays, or a cosmetic, quasi-pharmaceutical product, pharmaceutical, or food and beverage product containing ascorbic acid, ascorbic acid derivative, or their salts as the inhibitor.

Patent Document 2 proposes to provide an internal agent for oral administration and a skin cosmetic containing glucosylceramide extracted from pineapple as a wrinkle inhibitor that is excellent in safety and in suppressing wrinkles caused by exposure to ultraviolet rays, a decrease in water content of the epidermis, and epidermal thickening.

### CITED DOCUMENTS

### Patent Literature

Patent Document 1: JP-A-2019-11254
Patent Document 2: JP-A-2013-241370

### DISCLOSURE OF THE INVENTION

### Problems to be Solved by the Invention

The above-described Patent Document 1 describes that the cell proliferation rate was measured, and epidermal thickening was suppressed. However, it does not describe that the thickness of the epidermis was measured, and does not show a sufficient effect based on the thickness of the epidermis.

In addition, the above-described Patent Document 2 describes the volume ratio of wrinkles, the area ratio of wrinkles, the number of wrinkles, and the water content of the epidermis. However, it does not show a sufficient effect compared with Reference Example 1. Furthermore, there is no data on actually measuring the thickness of the epidermis in the description of Patent Document 2. Therefore, one of the objects is to provide a health food that has a sufficient effect based on data obtained by measuring the thickness of the epidermis.

The inventors tried to conduct an analysis using a new evaluation method using rats and decided to work on food and beverages that suppress epidermal thickening. It is an object of the present invention to provide a health food that suppresses thickening of the epidermis and, further, a health food that, in addition to this, has an action of increasing collagen in the dermis and the like.

### Solutions to the Problems

The inventors found an action of suppressing epidermal thickening by ingesting collagen, arginine, and nuclear protein components derived from plants, fish, and dairy products, and obtained knowledge that the action of suppressing epidermal thickening is further exerted by further ingesting magnesium carbonate, chondroitin, hyaluronic acid, zinc, citric acid, vitamin C, and the like. Based on the knowledge, the inventors completed the health food of the present invention.

The present invention has been completed based on the knowledge described above.

That is, one aspect of the present invention is:
1. A health food comprising collagen, nuclear protein, and arginine and having a suppressive action on epidermal thickening.
2. The health food according to [1], further comprising one or more kinds selected from the group consisting of magnesium carbonate, chondroitin, hyaluronic acid, zinc, citric acid, and Vitamin C.
3. The health food according to [1], wherein
the nuclear protein is one or more kinds selected from the group consisting of yeast-derived RNA, plant-derived RNA, fish-derived RNA, dairy-derived RNA, and salmon milt-derived DNA.
4. The health food according to [1], wherein
the nuclear protein is contained in an amount of 10 mass % or more based on a mass of the collagen.
5. The health food according to [1], wherein
the nuclear protein is in an amount of 0.5 mass % or more based on an overall mass of a health food.
6. The health food according to [1], wherein
the nuclear protein includes dinucleotides, trinucleotides, tetranucleotides, or pentanucleotides.
7. The health food according to [1], wherein the nuclear protein includes a dinucleotide content of 0.8 to 2.0 relative to a mononucleotide content of 1.
8. The health food according to [1], wherein
the nuclear protein includes a content of dinucleotides, trinucleotides, tetranucleotides, and pentanucleotides of 20% or more based on a nuclear protein content.
9. The health food according to any one of [1] to [8], further including an action of increasing a collagen content in the dermis.

### Effects of the Invention

The present invention provides a health food that is highly safe without any side effects and suppresses epidermal thickening.

In addition, the health food of the present invention can not only suppress a reduction in the thickness of the epidermis and dermis or a reduction in the collagen content in the dermis, but also promote an increase in the collagen content in the dermis.

### BRIEF DESCRIPTION OF THE DRAWINGS

FIG. 1 presents graphs showing the molecular weight of DNA in a salmon milt extract contained in an unimproved health food (beverage). [FIG. 1(a) shows a distribution A, and FIG. 1(b) shows distributions B to F.]

FIG. 2 presents graphs showing the molecular weight of DNA in a salmon milt extract contained in an improved health food (beverage). [FIG. 2(a) shows a distribution A, and FIG. 2(b) shows distributions B to F.]

FIG. 3 is a graph showing the average calorie intake of first to sixth groups.

FIG. 4 is a graph showing the body weight at the time of dissection of the first to sixth groups.

FIG. 5 presents photographs showing cross-sections of the epidermis of rats. In the drawing, FIG. 5(1), 5(2), 5(3), 5(4), 5(5), and 5(6) are photographs showing the cross-sections of the epidermis of a rat in the first group, a rat in the second group, a rat in the third group, a rat in the fourth group, a rat in the fifth group, and a rat in the sixth group, respectively.

FIG. 6 is a graph of the measured thicknesses of the epidermis of the rats in the first to sixth groups.

FIG. 7 presents photographs showing cross-sections of collagen-positive areas of rats. In the drawing, FIG. 7(1), 7(2), 7(3), 7(4), 7(5), and 7(6) are photographs showing the cross-sections of the collagen-positive areas of the rat in the first group, the rat in the second group, the rat in the third group, the rat in the fourth group, the rat in the fifth group, and the rat in the sixth group, respectively.

FIG. 8 is a graph showing the collagen-positive areas of the rats in the first to sixth groups.

### DESCRIPTION OF PREFERRED EMBODIMENTS

The following describes the present invention in more detail.

Health foods generally refer to foods that are effective in maintaining and promoting health, but there is no clear definition by administrative agencies and the like. A health food in the present invention includes confectionery, beverages, jellies, as well as tablets and capsules similar to pharmaceuticals (so-called supplements). Since health foods are not pharmaceuticals, there are no particular restrictions on the number of times ingested, the amount ingested, or the timing of ingestion, such as before or after meals.

The health food of the present invention is characterized by the fact that it can suppress the thickening of the human epidermis by containing a combination of collagen, nuclear proteins, and arginine. Since epidermal thickening is a phenomenon that tends to occur in women, especially postmenopausal women, including women during menopause, ingestion of the health food of the present invention is very useful in suppressing epidermal thickening in the above-described women. Suppression of epidermal thickening allows women to retain moisturized skin, maintain good blood flow and capillary density under the skin, and expect to prolong their healthy life expectancy. In addition, men secrete fewer female hormones and do not see a dramatic decrease in the amounts. Therefore, the health food of the present invention is an effective food not only for postmenopausal women but also for general men.

From the above, the subjects of ingestion of the health food of the invention are women during menopause, men during andropause, women after menopause, men after andropause, postmenopausal women, elderly women, and elderly men. Furthermore, other aspects of the present invention relate to a method of oral administration and use of the health food.

Specific substances that can be added to the health food of the present invention include, but are not limited to, the following substances.

The following describes the components contained in the health food of the present invention individually.

Examples of collagens include porcine collagen peptides, fish collagen peptides (including gelatin), collagen-containing mineral complexes, and the like. One of the collagens can be used alone, or a mixture of two or more of them can also be used.

Collagen is known to be present in large amounts in the dermis to regulate the texture of the skin and maintain moisture. Therefore, the inventors verified the components that suppressed epidermal thickening and a reduction in collagen in the dermis and the like by preparing rats that underwent oophorectomy, preparing collagen, nuclear proteins, and other components, and observing the state of epidermal thickening and the amount of collagen in the dermis and the like. From the results of the observational tests on the state of epidermal thickening and the amount of collagen in the dermis and the like, the inventors discovered components of health food that have a suppressive action on epidermal thickening and the reduction in collagen in the dermis and the like.

Nucleic acid contained in nuclear protein is a generic term for deoxyribonucleic acid (DNA), which retains genetic information, and ribonucleic acid (RNA), which transmits genetic information and synthesizes proteins according to the information possessed by DNA. Nucleic acids are substances that play an important role not only in cell proliferation and growth, but also in the maintenance of vital activity.

A water-soluble nuclear protein can be produced by removing skin, muscle, blood vessels, and the like from milt, purifying it, removing the oil content, and performing enzymatic decomposition treatment with nucleases and proteases. For example, milt of salmon, trout, herring, cod, and the like can be used as the milt.

Examples of the RNA include yeast-derived RNA, plant-derived RNA, fish-derived RNA, and dairy-derived RNA. Torula yeast, as yeast-derived RNA, has been recognized as safe for edible use by the United States Food and Drug Administration (FDA) and is being produced as a fungus body. Nucleic acids (RNA) extracted from the fungus body are used as health foods. In addition to torula yeast, examples of yeast include, for example, beer yeast, milk yeast, and baker's yeast, and extracts from these yeasts (especially RNA) can be used.

In addition to yeast extracts, RNA contained in plant-derived components, fish-derived components, and dairy-derived components can be used in the present invention.

In one aspect of the present invention, the health food contains RNA other than yeast extracts. The present invention uses, but is not limited to, plant-derived components, such as corn, wheat, soybeans, and rice, and fish-derived and dairy-derived components.

Ingesting arginine in combination with collagen activates an immune reaction, promotes cell proliferation, and promotes the production of collagen, thereby promoting the suppressive action of epidermal thickening in those who ingest it. With the expectation of this, arginine can be contained in the health food of the present invention.

The arginine contained in the health food of the present invention is not particularly limited as long as it can be added in an aspect that can be used in food, and examples include arginine alone or an aspect in which arginine molecules and acid molecules are combined.

Ingesting zinc in combination with nuclear proteins stimulates protein metabolism, activates the metabolism of the whole body including the skin, and improves the skin problems of those who ingest it. With the expectation of this, zinc can be contained in the health food of the present invention.

The zinc contained in the health food of the present invention is not particularly limited as long as it can be added in an aspect that can be used in food, and it can be ingested in an aspect of zinc gluconate, zinc sulfate, edible zinc yeast, and the like.

Since magnesium plays a role in promoting energy metabolism and protein synthesis and maintaining the function of all cells including blood vessels and nerves and can inhibit the progression of arteriosclerosis and aging due to magnesium deficiency, it maintains the cells of the epidermis and suppresses the progression of aging in those who ingest it. With the expectation of this, magnesium can be contained in the health food of the present invention.

Magnesium carbonate contained in the health food of the present invention is not particularly limited as long as it can be added in an aspect that is also an ethical pharmaceutical and can be used in food. In the present invention, instead of magnesium carbonate or a part thereof, magnesium oxide, magnesium chloride, and the like may be added as a magnesium salt.

Chondroitin is said to have a high water retention property. Therefore, chondroitin can be contained in the health food of the present invention with the expectation of beauty and anti-aging effects by, for example, improving the water retention property of the skin and giving the skin moisture, firmness, luster, and elasticity, and also with the expectation of a role in suppressing the thickening of the epidermis of those who ingest it.

The chondroitin contained in the health food of the present invention is one kind of glycosaminoglycans (mucopolysaccharides), and examples include chondroitins, including chondroitin whose basic structure is a structure in which sulfuric acid is bound to a sugar chain where the disaccharides of D-glucuronic acid (GlcA) and N-acetyl-D-galactosamine (GalNAc) are repeated, its derivatives, and their salts.

Hyaluronic acid is a component that originally exists in living organisms but is known to begin to decrease after reaching a peak at the age of 20. Therefore, hyaluronic acid can be contained in the health food of the present invention with the expectation that it retains water inside the skin and brings moisture and flexibility to the whole skin.

The hyaluronic acid contained in the health food of the present invention is one kind of proteoglycans, and examples include hyaluronic acids, including hyaluronic acid whose basic structure is a structure in which disaccharide units with the first position of β-D-glucuronic acid and the third position of β-D-N-acetylglucosamine bonded together are linked, its derivatives, and their salts. In addition, examples of the hyaluronic acid in the present invention can include low-molecular-weight hyaluronic acid or hyaluronan degradants obtained by performing enzymatic treatment using hyaluronidase and the like, or heating and pressurizing treatment on such hyaluronic acids. Specific examples of hyaluronic acid that can be added to the health food include a chicken crown extract and the like.

Furthermore, hyaluronic acid or its salt may be extracted from biological tissues of animals and the like (such as umbilical cords, skin, joint fluid, in addition to chicken crowns). Alternatively, the one derived from culturing microorganisms, animal cells, or plant cells, the one synthesized chemically or enzymatically, and the like can be used.

Vitamins are essential not only for beautiful skin but also for health. Therefore, vitamins, including vitamin C, can be added to the health food of the present invention with the expectation of the effect of avoiding the occurrence of skin troubles due to their deficiency and suppressing the thickening of the epidermis of those who ingest it.

Vitamins are not particularly limited as long as they are vitamins or their derivatives capable of providing the effects of the present invention, or their salts. Examples include, for example, vitamin C (ascorbic acid, sodium ascorbate, ascorbic acid derivatives) and other vitamins that can be generally contained in health foods.

Citric acid can be used as an acidulant and a pH regulator. In addition to citric acid, sodium citrate, lactic acid, sodium lactate, glycolic acid, succinic acid, acetic acid, sodium acetate, malic acid, tartaric acid, fumaric acid, and the like can be used as a pH regulator.

Other components include high-fructose corn syrup, white superior soft sugar, syrup containing rare sugar, sweeteners such as erythritol and sucralose, fruit juice such as pineapple juice, preservatives such as sodium benzoate, colorants such as caramel coloring, emulsifiers (for example, those derived from soybeans), flavoring agents, and acidulants. In addition, the present invention may contain raw materials other than the above, to the extent that the effects of the present invention are not impaired. Examples of such raw materials include water, excipients, antioxidants, preservatives, wetting agents, viscosity agents, buffering agents, adsorbents, solvents, stabilizers, surfactants, lubricants, and water-soluble polymers. When the health food of the present invention contains any of these other components, an appropriate amount of each component may be added.

The present invention may also contain other medicinally active compounds.

The dosage of the health food of the present invention depends on age, body weight, sensitivity of the patient, degree of skin condition, and the like. The health food can usually be ingested, for example, in an amount of 30 ml or more, preferably 60 ml or more, at a time as a beverage.

In the present invention, the molecular weight of DNA and the component ratio of nuclear proteins and collagen are important.

Nuclear proteins (nucleic acids) can be combined in a range of 0.5 mass % or more per 100 mass % of food, preferably 1.5 mass % or more, and further preferably 2.0 mass % or more.

For collagen, the ratio relative to nuclear proteins is important. Therefore, based on the mass of collagen, nuclear proteins (nucleic acids) can be combined in a range of 10 mass % or more, preferably 15 mass %, and further preferably 20 mass % or more.

With respect to the molecular weight of DNA, mononucleotides, dinucleotides, trinucleotides, tetranucleotides, and pentanucleotides can be combined in the total content of 20% or more, preferably 30% or more, further preferably 40% or more, and particularly preferably 50% or more, relative to the content of nuclear proteins contained in a salmon milt extract.

The content of dinucleotides, trinucleotides, tetranucleotides, and pentanucleotides is also important in the molecular weight distribution of DNA in the present invention. Dinucleotides, trinucleotides, tetranucleotides, and pentanucleotides can be combined in the total content of 10% or more, preferably 20% or more, further preferably 25% or more, and particularly preferably 30% or more, relative to the content of nuclear proteins contained in the salmon milt extract.

Furthermore, the content ratio of mononucleotides to dinucleotides is also important in the molecular weight distribution of DNA in the present invention. Dinucleotides can be combined in the content of 0.7 to 2.0, preferably 0.8 to 2.0, further preferably 0.9 to 2.0, and particularly preferably 0.9 to 1.5, relative to the mononucleotide content of 1 in the content of nuclear proteins contained in the salmon milt extract.

In addition, the content of dinucleotides and trinucleotides is also important in the molecular weight distribution of DNA in the present invention. Dinucleotides can be combined in the content of 5% or more, preferably 10% or more, further preferably 13% or more, and particularly preferably 15% or more, relative to the content of nuclear proteins contained in the salmon milt extract.

Moreover, trinucleotides can be combined in the content of 1% or more, preferably 3% or more, further preferably 5% or more, and particularly preferably 10% or more, relative to the content of nuclear proteins contained in the salmon milt extract.

It is only necessary to mix the health food of the present invention with various components, such as known sweeteners, acidulants, and vitamins, into a product that suits the user's preferences. The health food of the present invention may be, for example, a drink as a beverage, or in other solid, powdered, or granular form, and it can be provided in the form of dairy products such as jellies and yogurts, seasonings, processed foods, supplements, tablets, capsules, desserts, confectionery, and the like.

The production process of these health foods is not specifically limited. However, for example, the intended health foods can be produced by adding the sweeteners and the like using appropriate means during the processing of health foods.

The health food of the present invention is effective as female technology and feminine care to alleviate symptoms peculiar to women. The health food is expected to improve skin thickening likely to occur on humans during menopause, humans after menopause, postmenopausal women, and elderly humans and also to improve collagen amount reduction in the dermis.

Examples of ingredients of the health food of the present invention is shown below.

### Health Food Example 1

Beverage (Compounding ratio, Unit: Mass %)
Water-soluble nuclear protein-containing extract 0.3 to 3.0
Collagen-containing substance 5.0 to 20.0
Arginine 0.05 to 0.5
Magnesium carbonate 0.1 to 1.0
Chondroitin 0.01 to 0.1
Hyaluronic acid 0.001 to 0.01
Zinc 0.01 to 0.5
Vitamin C 0.3 to 3.0
Vitamins other than vitamin C 0.01 to 0.3
Citric acids 0.5 to 5.0
Sugars 5.0 to 20.0
Other added ingredients Appropriate amount
(Examples that may be contained as other added ingredients: Flavoring agents, emulsifiers, colorants, and the like)

### Health Food Example 2

Jelly (Compounding ratio per 15 g, Unit: Mass%)
Water-soluble nuclear protein-containing extract 0.3 to 3.0
Collagen-containing substance 5.0 to 20.0
Arginine 0.05 to 0.5
Magnesium carbonate 0.1 to 1.0
Zinc 0.01 to 0.5
Vitamin C 0.3 to 3.0
Vitamins other than vitamin C 0.01 to 0.3
Other added ingredients Appropriate amount
(Examples that may be contained as other added ingredients: Gelatin, chondroitin, hyaluronic acid, citric acids, sweeteners, sugars, fruit puree, and the like)

### Health Food Example 3

Capsule-type supplement (Compounding ratio per 12 capsules, Unit: Mass%)
Water-soluble nuclear protein-containing extract 0.3 to 3.0
Collagen-containing substance 5.0 to 20.0
Arginine 0.05 to 0.5
Magnesium carbonate 0.1 to 1.0
Zinc 0.01 to 0.5
Vitamin C 0.3 to 3.0
Vitamins other than vitamin C 0.01 to 0.3
Other added ingredients Appropriate amount
(Examples that may be contained as other added ingredients: Beer yeast, ginkgo leaf extract, odorless garlic extract, porcine planter extract, dextrin, gelatin, chondroitin, hyaluronic acid, copper, sugars, sucrose fatty acid esters, sodium ferrous citrate, calcium pantothenate, and the like)

### EXAMPLES

The following specifically describes one aspect of the present invention by giving examples. However, the present invention is not limited to the following examples. The rats, feeds, and the like used in the examples are as follows.

### 1. Rearing Rats

Female SD rats were introduced at the age of three weeks, divided into six groups (grouping to be described in the next section) so as to be averaged in body weight, and fed with experimental feed after acclimation. In the second, fourth, and sixth groups, oophorectomy (OVX treatment) was performed on the seventh day after the start of experimental feed administration to create postmenopausal pathological models. It is said that OVX treatment generally causes a decrease in epidermal water content and a decrease in the ability to restore the skin barrier function. OVX treatment has a meaning not only as postmenopausal models, but also as pathological models in which the skin condition is not normal and pathological models prone to epidermis thickening.

In the first and second groups, 1 mL/300 g (body weight) per day of placebo (beverage) was ingested by forced oral administration from one week before OVX treatment. In the third and fourth groups, 1 mL/300 g (body weight) per day of unimproved health food (beverage) of the present invention was ingested by forced oral administration from one week before OVX treatment. In the fifth and sixth groups, 1 mL/300 g (body weight) per day of (improved) health food (beverage) of the present invention, in which the molecular weight distribution of DNA contained in a salmon milt extract was improved, was ingested by forced oral administration from one week before OVX treatment. The rats in the first to sixth groups were dissected seven weeks after OVX treatment, and their skin was removed and analyzed.

### 2. Materials and Method

### 2-1. Health Foods Using Unimproved and Improved Water-Soluble Nuclear Protein-Containing Extracts

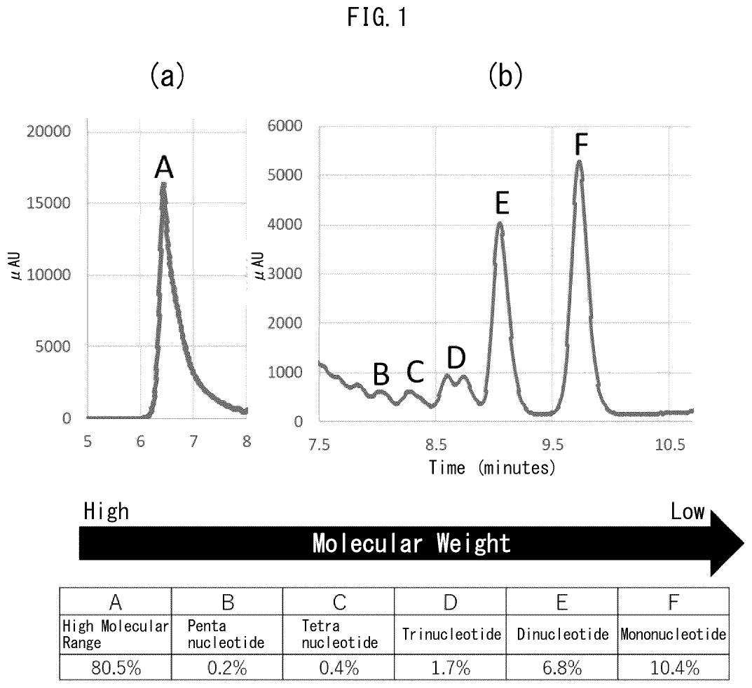

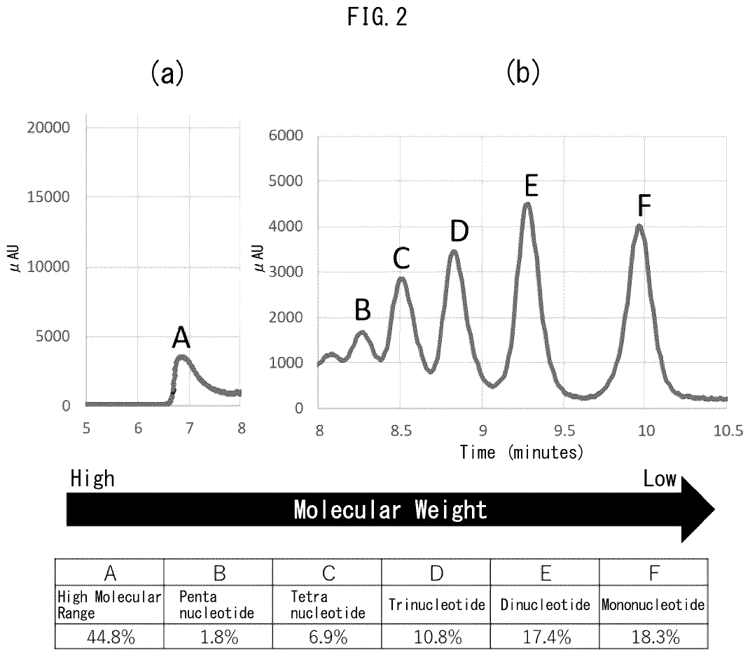

A health food containing a water-soluble nuclear protein-containing extract with an improved molecular weight distribution of DNA of nuclear protein contained in a salmon milt extract and a health food containing an unimproved water-soluble nuclear protein-containing extract were prepared. The improved water-soluble nuclear protein-containing extract was achieved by adjusting hydrolysis conditions (such as temperature and enzyme level), and the molecular weight distribution (oligonucleotide amount) changed compared to the unimproved water-soluble nuclear protein-containing extract. Graphs of the molecular weight distribution are shown in FIG. 1 (unimproved) and FIG. 2 (improved).

Comparing FIGS. 1 and 2, it can be seen that the content of oligonucleotides increased. In particular, since the usefulness of trinucleotides was found, the content of trinucleotides was increased.

Measuring instrument for molecular weight distribution: HPLC Prominence System manufactured by Shimadzu Corporation (Online degassing unit: DGU20A, Pump unit (with high pressure gradient unit): LC20AD, Autosampler: SIL20AC (HT))

### 2-2. Experimental Animals and Their Rearing Environment

Female SD rats were purchased from SHIMIZU Laboratory Supplies Co., Ltd., at the age of three weeks and maintained in an animal rearing room in Kindai University.

### 2-3. Grouping

Rats were weighed at the time of introduction and divided to be averaged in body weight. The treatment method, type of beverage, and number of rats by group were set as follows.
First group: Placebo beverage ingestion group without OVX treatment: 6 rats
Second group: Placebo beverage ingestion group with OVX treatment performed: 7 rats
Third group: Group ingesting the unimproved health food (beverage) of the present invention without OVX treatment: 6 rats
Fourth group: Group ingesting the unimproved health food (beverage) of the present invention with OVX treatment performed: 7 rats
Fifth group: Group ingesting the health food (beverage) of the present invention in which the molecular weight distribution of DNA contained in the salmon milt extract was improved, without OVX treatment: 6 rats
Sixth group: Group ingesting the health food (beverage) of the present invention in which the molecular weight distribution of DNA contained in the salmon milt extract was improved, with OVX treatment performed: 7 rats

The compounding ratio of the placebo is shown below.
Placebo beverage (Compounding ratio, Unit: Mass %)
Sugars 10
Citric acids 2
Dextrin 13
Other added ingredients Appropriate amount (Other added ingredients: Emulsifiers, colorants, and the like)

### 2-4. Feed

The feed was prepared at Kindai University. The prepared feed was cryogenically preserved until it was used. The composition is as follows.
Control fat feed (g)
Casein 200
Maltodextrin 125
Sucrose 68.8
Cellulose 50
AIN-93G mineral 32
Calcium hydrogen phosphate 13
AIN-93 vitamin mixture 10
Cystine 3
Choline chloride 2
Cornstarch 506.2
Lard 20
Olive oil 25
Total 1055
Kcal/g 3.85

During acclimation, all groups were fed with normal (experimental) feed MF (Oriental Yeast Co., Ltd.).

### 2-5. Measuring the Amount of Feed Ingested

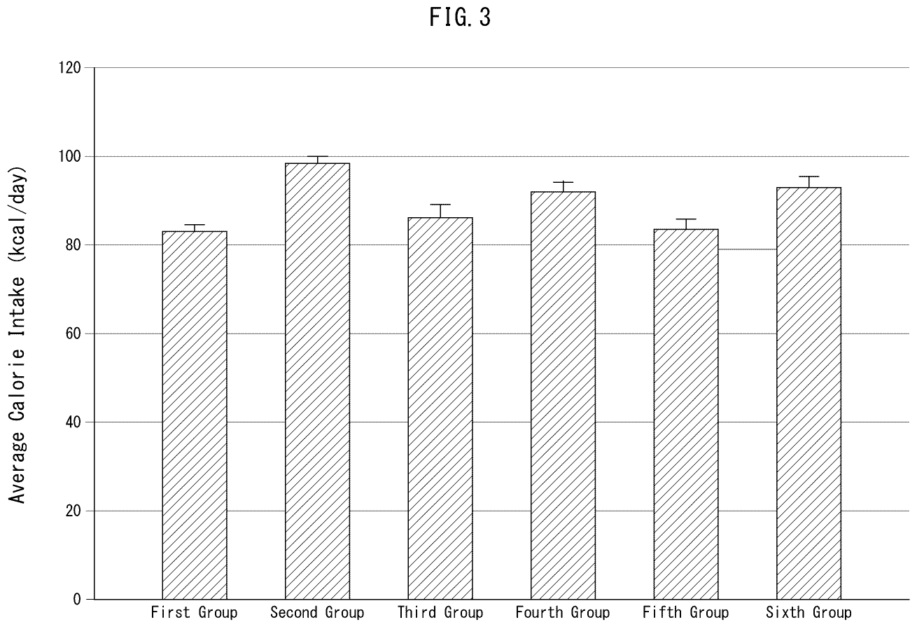

The average calorie intake measurement was calculated from the measurement of the amount of feed ingested. Floor covering was replaced on the day before the amount of feed was measured, and the experimental feed was measured. About 24 hours later, the amount of feed ingested was calculated as the difference between the sum of the mass of the experimental feed and the mass of the experimental feed that fell on the floor covering, and the mass of the experimental feed of the previous day. FIG. 3 shows the average calorie intake of the first to sixth groups.

### 2-6. Measuring Body Weight

The body weight of the rats was measured at the time of introduction, and after feeding of the experimental feed was started, the body weight was measured once a week between 10:00 a.m. and 11:00 a.m. There was a significant increase in final body weight in the OVX-treated groups compared with the OVX-untreated groups. Both the OVX-untreated groups and the OVX-treated groups showed no significant differences in the administration of the invention product.

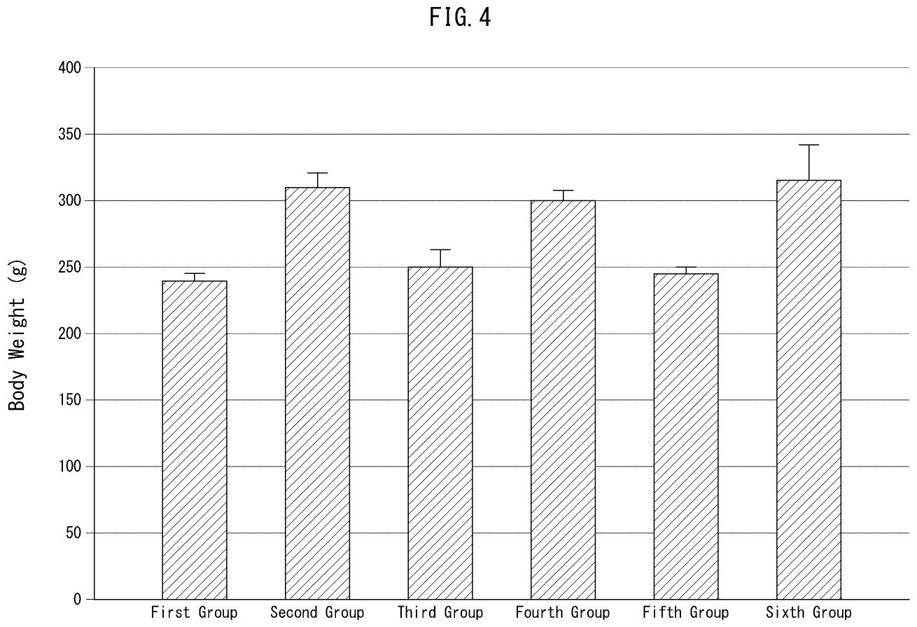

FIG. 4 shows the body weight at the time of dissection of the first to sixth groups.

### 3. Method for Measuring Epidermis Thickness and Collagen Content

### 3-1. Epidermis Thickness Measurement (H&E Stain)

Tissue specimens were prepared by the dissection seven weeks after OVX treatment and the removal of the skin. Epidermis thickness measurement was evaluated by staining a tissue slice with haematoxylin and eosin (H&E) and measuring the thickness of the epidermis portion.

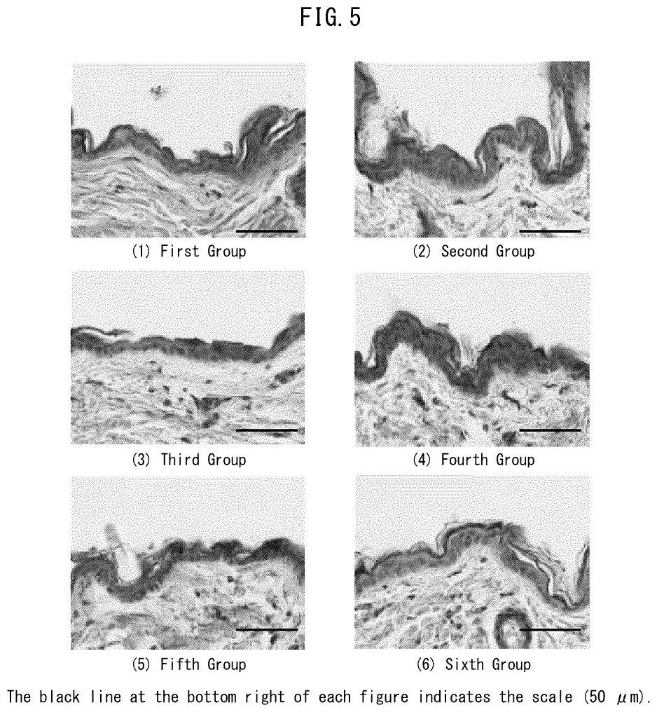

FIG. 5 is a drawing showing the states of the epidermis of the rats. Each figure in FIG. 5 shows the inside of the skin on the lower side, presenting the darker-colored part as the epidermis. Comparing the first group and the second group as the placebo beverage ingestion groups, it can be seen that the darker-colored part, that is, the epidermis portion, of the second group with OVX treatment performed is thicker than the darker-colored part of the first group without OVX treatment. Comparing the third and fifth groups and the fourth and sixth groups as the groups ingesting the beverages of the present invention, it can be seen that the darker-colored parts, that is, the epidermis portions, of the fourth and sixth groups with OVX treatment performed are equal in thickness compared to the darker-colored parts of the third and fifth groups without OVX treatment.

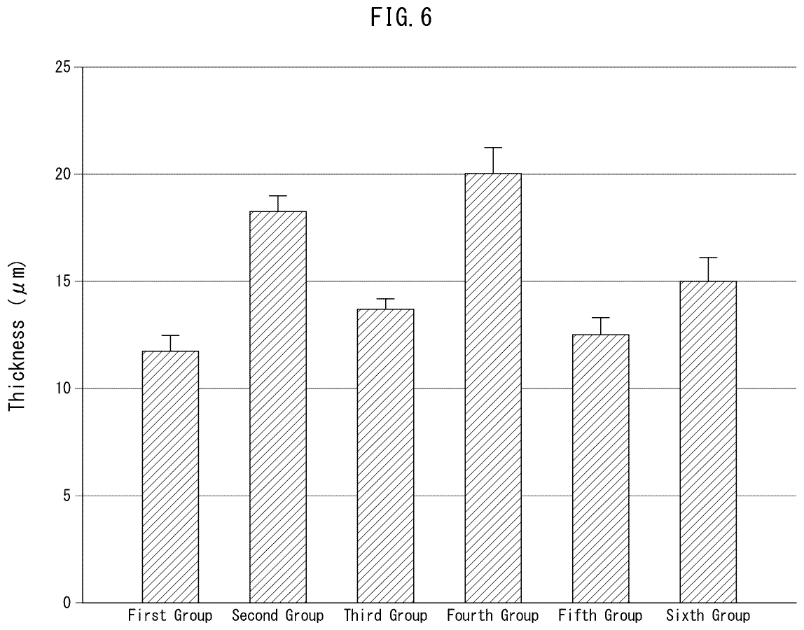

FIG. 6 is a graph of the measured thicknesses of the epidermis of the rats. Comparing the first group and the second group as the placebo beverage ingestion groups, it can be seen that the epidermis thickness in the second group with OVX treatment performed increased by about 6.7 μm in the average value for each group, based on the epidermis thickness in the first group without OVX treatment.

Comparing the third group and the fourth group as the groups ingesting the unimproved beverage of the present invention, it can be seen that the epidermis thickness in the fourth group with OVX treatment performed increased by about 6.4 μm in the average value for each group, based on the epidermis thickness in the third group without OVX treatment.

Comparing the fifth group and the sixth group as the groups ingesting the improved beverage of the present invention, it can be seen that the epidermis thickness in the sixth group with OVX treatment performed increased by about 2.6 μm in the average value for each group, based on the epidermis thickness in the fifth group without OVX treatment.

From the above, it is inferred that epidermis thickening occurs by performing OVX treatment. Compared with the average values of the epidermis thickness in the groups ingesting the placebo, the average values of the epidermis thickness in the groups ingesting the improved health beverage of the present invention were found to be suppressed to 1/2.5(2.6/6.7 ) or less.

Note that the comparison of the average value of the epidermis thickness in the group ingesting the unimproved health beverage and the average value of the epidermis thickness in the group ingesting the improved health beverage also showed an improvement from the increase by 6.4 μm to the increase by 2.6 μm.

### 3-2. PSR Stain

For the collagen content in the dermis, the state of collagen-positive areas inside the skin was observed.

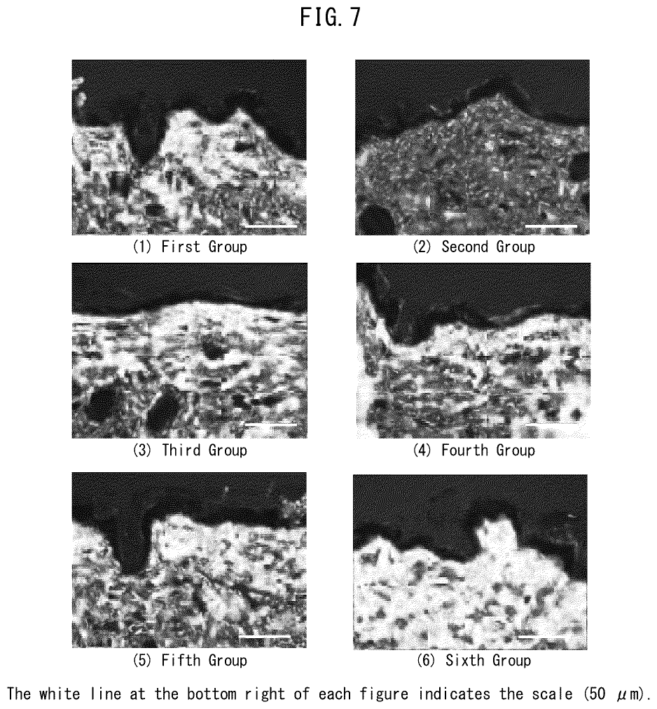

FIG. 7 is a drawing showing the states of the collagen-positive areas of the rats. Each figure in FIG. 7 shows the inside of the skin on the lower side. The white-colored parts in each figure in FIG. 7 shown in a black and white photograph (strong red parts in a color photograph are represented as bright white) are collagen-containing parts of the dermis. Comparing the first group and the second group as the placebo beverage ingestion groups, it can be seen that the white-colored parts, that is, the collagen-containing parts, of the second group with OVX treatment performed are less than the white-colored parts of the first group without OVX treatment. Comparing the third and fifth groups and the fourth and sixth groups as the groups ingesting the beverages of the present invention, it can be seen that the white-colored parts, that is, the collagen-containing parts, of the fourth and sixth groups with OVX treatment performed significantly increased compared to the white-colored parts of the third and fifth groups without OVX treatment.

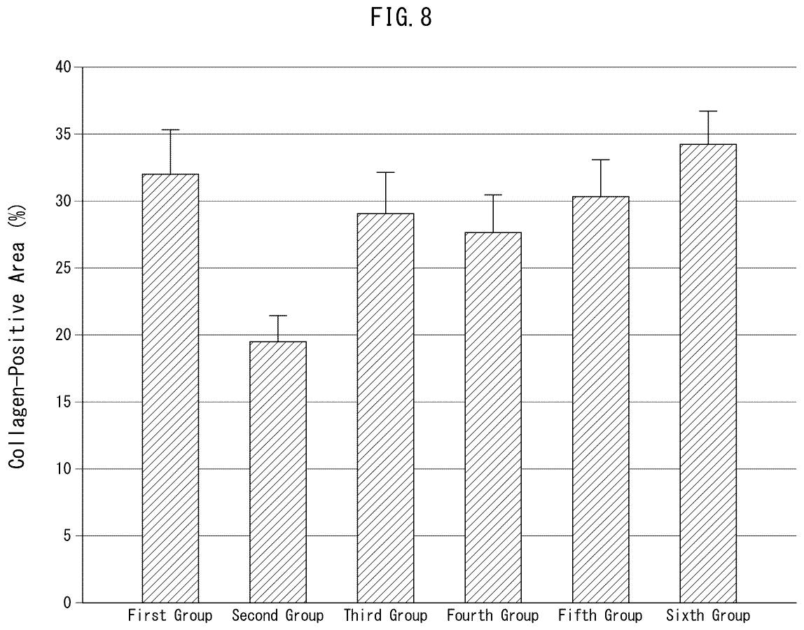

FIG. 8 is a graph showing the collagen-positive areas (%) of the rats. Comparing the first group and the second group as the placebo beverage ingestion groups, it can be seen that the collagen-positive area in the second group with OVX treatment performed decreased by about 12.5% in the average value for each group, based on the thickness of the collagen-positive area in the first group without OVX treatment.

Comparing the third group and the fourth group as the groups ingesting the beverage of the present invention, it can be seen that the thickness of the collagen-positive area in the fourth group with OVX treatment performed increased by about 1.9% in the average value for each group, based on the collagen-positive area in the third group without OVX treatment.

Comparing the fifth group and the sixth group as the groups ingesting the beverage of the present invention, it can be seen that the thickness of the collagen-positive area in the fourth group with OVX treatment performed increased by about 3.8% in the average value for each group, based on the collagen-positive area in the fifth group without OVX treatment.

From the above, it is inferred that the collagen-positive area decreases by performing OVX treatment when ingesting the placebo.

However, it was found that the collagen-positive area increased rather than decreased by ingesting the health beverage of the present invention, even when OVX treatment was performed. It was found that ingesting the health beverage of the present invention plays a role in not only suppressing a reduction in collagen but also promoting an increase in collagen.

### INDUSTRIAL APPLICABILITY

The health food of the present invention can maintain the skin condition well by ingesting it. The product of the present invention is useful as a beauty and health food.

1. A health food comprising collagen, nuclear protein, and arginine and having a suppressive action on epidermal thickening, wherein the nuclear protein is 0.5% by mass or more with respect to the total mass of the health food,
the nuclear protein has mononucleotides, dinucleotides, trinucleotides, tetranucleotides and pentanucleotides.
the content of the dinucleotides is 0.8 to 2.0 with respect to the content of the mononucleotides of 1,
the content of the dinucleotides, the trinucleotides, the tetranucleotides and the pentanucleotides is 20% or more with respect to the content of the nuclear protein,
the content of the mononucleotides, the dinucleotides, the trinucleotides, the tetranucleotides and the pentanucleotides is 30% or more with respect to the content of the nuclear protein;
the content of the dinucleotides is 10% or more with respect to the content of the nuclear protein, and
the content of the trinucleotides is 3% or more with respect to the content of the nuclear protein.

2. The health food for suppressing epidermal thickening according to claim 1, further comprising one or more kinds selected from the group consisting of magnesium carbonate, chondroitin, hyaluronic acid, zinc, citric acid, and Vitamin C.

3. The health food for suppressing epidermal thickening according to claim 1, wherein nucleic acid contained in the nuclear protein is one or more kinds selected from the group consisting of yeast-derived RNA, plant-derived RNA, fish-derived RNA, dairy-derived RNA, and salmon milt-derived DNA.

4. The health food for suppressing epidermal thickening according to claim 1, wherein
the nuclear protein is contained in an amount of 10 mass % or more based on a mass of the collagen.

5. (canceled)

6. (canceled)

7. (canceled)

8. (canceled)

9. The health food for suppressing epidermal thickening according to claim 1, further comprising an action of increasing a collagen content in the dermis.

10. The healthy food for suppressing epidermal thickening according to 9, wherein the healthy food has an activity of suppressing epidermal thickening in humans during and after menopause.
